(19) United States
(12) Patent Application Publication
(10) Pub. No.: US 2026/0119768 A1
(43) Pub. Date: Apr. 30, 2026

(54) CIRCUIT DESIGN VOLTAGE VERIFICATION

(71) Applicant: International Business Machines Corporation, Armonk, NY (US)

(72) Inventors: Gabor DRASNY, Poughkeepsie, NY (US); Maya SAFIEDDINE, Pflugerville, TX (US); Faith CURTIS, Wappingers Falls, NY (US); Ali S. EL-ZEIN, Austin, TX (US)

(21) Appl. No.: 18/930,290

(22) Filed: Oct. 29, 2024

(51) Int. Cl. G06F 30/367; G06F 119/06

(52) U.S. Cl. CPC G06F 30/367; G06F 2119/06

(57) ABSTRACT

The present disclosure describes a computer system for performing voltage verification. The computer system performs an operation including receiving a circuit design that includes a first instance of a module and retrieving a design of the module. The operation also includes determining (i) a first global voltage mapped to a first local voltage for the first instance of the module and (ii) a second global voltage mapped to a second local voltage for the first instance of the module, determining an allowed direct crossing from the second global voltage to the first global voltage, and based on the allowed direct crossing from the second global voltage to the first global voltage, adjusting the design of the module such that a first component of the design is powered using the first local voltage.

### BACKGROUND

The present disclosure relates to circuit design, and more specifically, to voltage verification of circuit designs.

### SUMMARY

The present disclosure describes a computer system for performing voltage verification. According to an embodiment, the computer system includes a processor set, one or more computer-readable storage media, and program instructions stored on the one or more storage media to cause the processor set to perform operations. The operations include receiving a circuit design that includes a first instance of a module and retrieving a design of the module. The design of the module includes (i) a first pin corresponding to a first local voltage, (ii) a second pin corresponding to a second local voltage, and (iii) a first component, and wherein the first component comprises (i) a first input corresponding to the first local voltage and (ii) a second input corresponding to the second local voltage. The operations also include determining (i) a first global voltage mapped to the first local voltage for the first instance of the module and (ii) a second global voltage mapped to the second local voltage for the first instance of the module, determining an allowed direct crossing from the second global voltage to the first global voltage, and based on the allowed direct crossing from the second global voltage to the first global voltage, adjusting the design of the module such that the first component is powered using the first local voltage. Other embodiments include a method performed by the computer system and a computer program product that includes one or more non-transitory computer readable media storing instructions to perform the operations.

### BRIEF DESCRIPTION OF THE DRAWINGS

FIG. 1 illustrates an example operation.

FIG. 2 illustrates an example operation.

FIG. 3 illustrates an example table.

FIG. 4 illustrates an example table.

FIGS. 5A through 5D illustrate an example circuit design adjustment.

FIG. 6 is a flowchart of an example method.

FIG. 7 shows an example computer environment.

### DETAILED DESCRIPTION

Electronic circuit designs are verified prior to finalizing the circuit designs and proceeding to manufacturing. One of the most difficult and time consuming steps in the verification process is checking for illegal voltage crossings (e.g., in portions of the designs that include combinatorial logic). During this step, the circuit design is evaluated to determine whether signals generated by components powered using one voltage (which may also be referred to as a global voltage) are directed to another component powered using a different voltage. This occurrence may be referred to as a voltage crossing in which the signals cross voltage domains. In some instances, voltage crossings may be acceptable or may become acceptable with the addition of other circuit components (e.g., level translators), but in other instances, the voltage crossings may cause the circuit to function incorrectly (these voltage crossings may be referred to as illegal voltage crossings). In some instances, using certain global voltages to power certain components may avoid illegal voltage crossings (e.g., by creating acceptable voltage crossings). The process of determining whether every module in a circuit design can be powered such that there are no illegal voltage crossings expends a significant amount of computing resources and time.

The present disclosure describes a computer system that takes advantage of the hierarchical design of circuit designs to improve the verification process related to voltage crossings. The computer system recognizes that a hierarchical circuit design may include multiple instances of a module (e.g., the same elaborated version of a module that shows the internal components and internal connections within the module). These instances may include the same components with the same connections between the components. The components in different instances may be connected to different global voltages. Instead of verifying the voltage crossings for each instance separately, the computer system checks for voltage crossings that may occur in the module design itself. The module design shows the components and connections in the module, and the module design is instantiated multiple times in the circuit design to create the modules in the circuit design.

As an example, the computer system may determine whether the voltage labels in the module design (e.g., annotations in the module design indicating whether signals received at the pins of the module design belong to different voltage domains, which may also be referred to as local voltages) indicate voltage crossings. The computer system then references a first table that maps the local voltages in the module design to the global voltages for each instance of the module to determine the global voltages implicated by the voltage crossing. The global voltages indicate the voltage domains to which the actual signals received by the instances of the module design in the circuit design belong. The computer system references a second table that indicates the voltage crossings of the global voltages that are allowed. The second table may also indicate the voltage crossings that are not allowed (e.g., either explicitly or implicitly through omission). Using the information in the first table and the second table, the computer system may determine whether it is possible to avoid illegal voltage crossings in the circuit design by assigning certain components in the module design to certain voltage domains indicated by the local voltages (e.g., by using particular local voltages to power certain components in the module design). The computer system then adjusts the module design (e.g., by adding a voltage label, changing metadata, etc.) to indicate that illegal voltage crossings may be avoided and to indicate how to avoid illegal voltage crossings.

In certain embodiments, the computer system provides several technical advantages. For example, by verifying voltage crossings at the module design level rather than the module instance level, the computer system reduces the number of voltage crossing checks that are performed to verify the circuit design. By reducing the number of voltage crossing checks, the computer system reduces the amount of computing resources and time used to verify the circuit design. As a result, the operation and function of the computer system is improved.

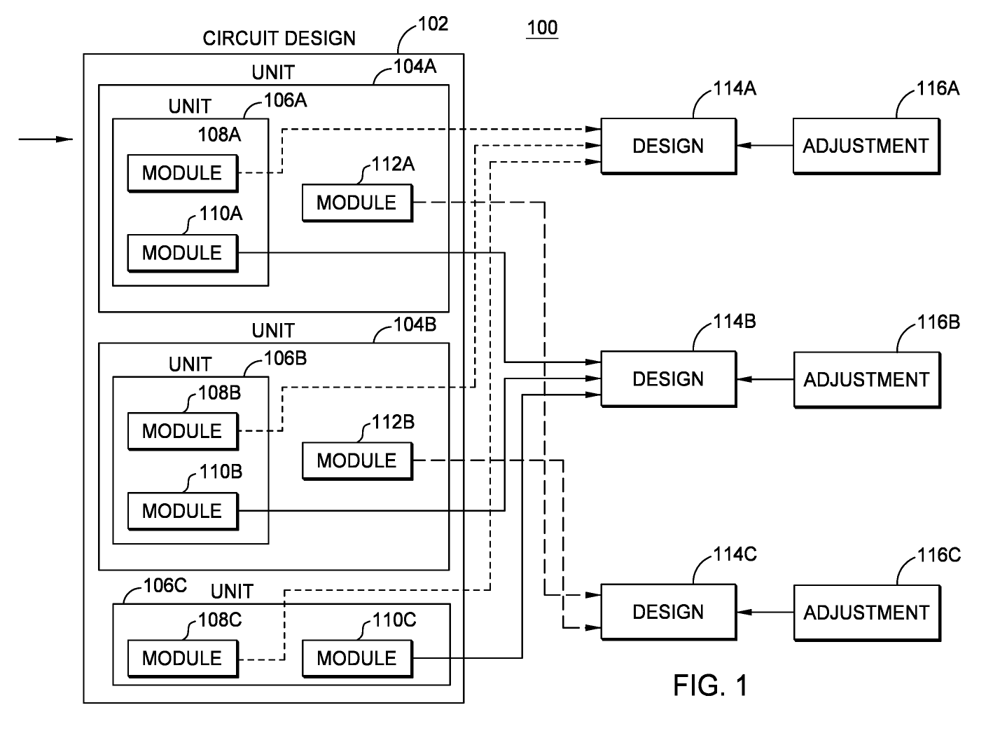

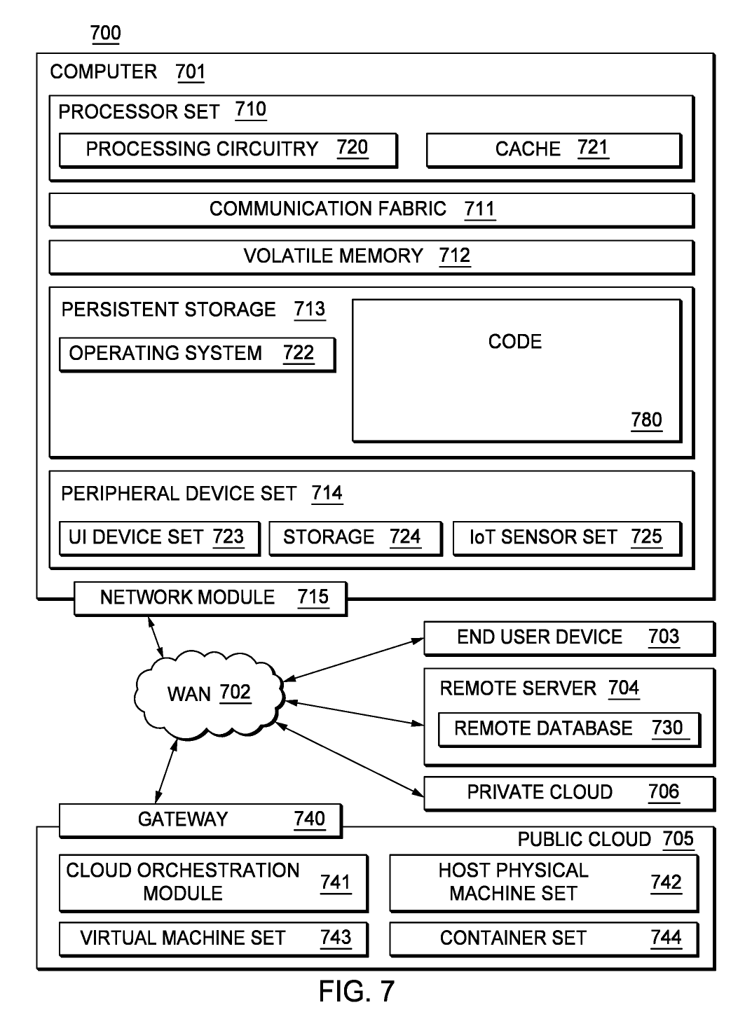

FIG. 1 illustrates an example operation 100. A computer system (e.g., that includes the computer 701 shown in FIG. 7) performs the operation 100 to verify voltage crossings in a circuit design 102. Generally, the computer system verifies the voltage crossings at the design level rather than at the instance level. In this manner, the computer system verifies voltage crossings in less time than existing systems and may use less computing resources verifying voltage crossings.

The circuit design 102 is a hierarchical circuit design that includes multiple units 104. The units 104 may also include units 106. Units 106 may also be included in the circuit design 102 outside of units 104. The units 106 may include modules 108 and 110. Additionally, the units 104 may include a module 112. In the example of FIG. 1, the circuit design 102 includes the units 104A and 104B. The units 104A and 104B include the units 106A and 106B. A unit 106C is also included in the circuit design 102 outside the units 104A and 104B. The unit 106A includes the modules 108A and 110A. The unit 106B includes the modules 108B and 110B. The unit 106C includes the modules 108C and 110C. The unit 104A also includes the module 112A, and the unit 104B also includes the module 112B. The modules 108A, 108B, and 108C may be instances of the same module, and the modules 110A, 110B, and 110C may be instances of the same module. Additionally, the modules 112A and 112B may be instances of the same module. For example, the modules 108A, 108B, and 108C may share the same design 114A, and the modules 110A, 110B, and 110C may share the same design 114B. The modules 112A and 112B may share the same design 114C. As a result, the modules 108A, 108B, and 108C may include the same electrical components and connections, the modules 110A, 110B, and 110C may include the same electrical components and connections, and the module 112A may include the same electrical components and connections as the module 112B. The modules 108A, 108B, and 108C may be connected to different external modules or components in the circuit design 102. The modules 110A, 110B, and 110C may be connected to different external modules or components in the circuit design 102. Likewise, the module 112A may be connected to different external modules or components in the circuit design 102 as the module 112B.

Instead of analyzing the voltage crossings in each individual module 108A, 108B, 108C, 110A, 110B, 110C, 112A, and/or 112B, the computer system analyzes voltage crossings in the designs 114 of the modules. There may be annotations in the designs 114 that indicate the voltage domains to which signals received at the design 114 belong (which may be referred to as “local voltages”). The computer system may determine whether there are voltage crossings in the designs 114 using the local voltages. For example, a component in the design 114 (e.g., a logic gate) may have inputs that receive signals from different voltage domains, introducing a voltage crossing at the component. The computer system may determine, using a table, the voltages in the circuit design 102 (which may be referred to as “global voltages”) that map to the local voltages for the inputs. The computer system may then determine, using a table, the legal and/or illegal voltage crossings involving these global voltages.

The computer system then determines whether the component may be assigned a local voltage that avoids illegal voltage crossings when that local voltage is mapped or translated to the global voltages in the circuit design 102. If so, the computer system may consider the voltage crossings for the component to be verified. The computer system may make an adjustment 116 to the design 114 to indicate the legal voltage crossing for the component. For example, the computer system may add a label to the component in the design 114 to indicate what local voltage for the component (e.g., the local voltage that may be used to power the component). This label may then be used in the circuit design 102 to indicate what global voltages should power the different instances of the component in the corresponding modules of the circuit design 102. As another example, the computer system may adjust the metadata for the design 114 to indicate that the voltage crossings for the component are verified and to indicate the local voltage to which the component should be assigned. The computer system may repeat this process for the various designs 114 instantiated in the circuit design 102. In the example of FIG. 1, the computer system determines and makes adjustments 116A, 116B, and 116C to the designs 114A, 114B, and 114C, respectively. In this manner, the computer system verifies voltage crossings in the circuit design 102 more quickly than existing systems.

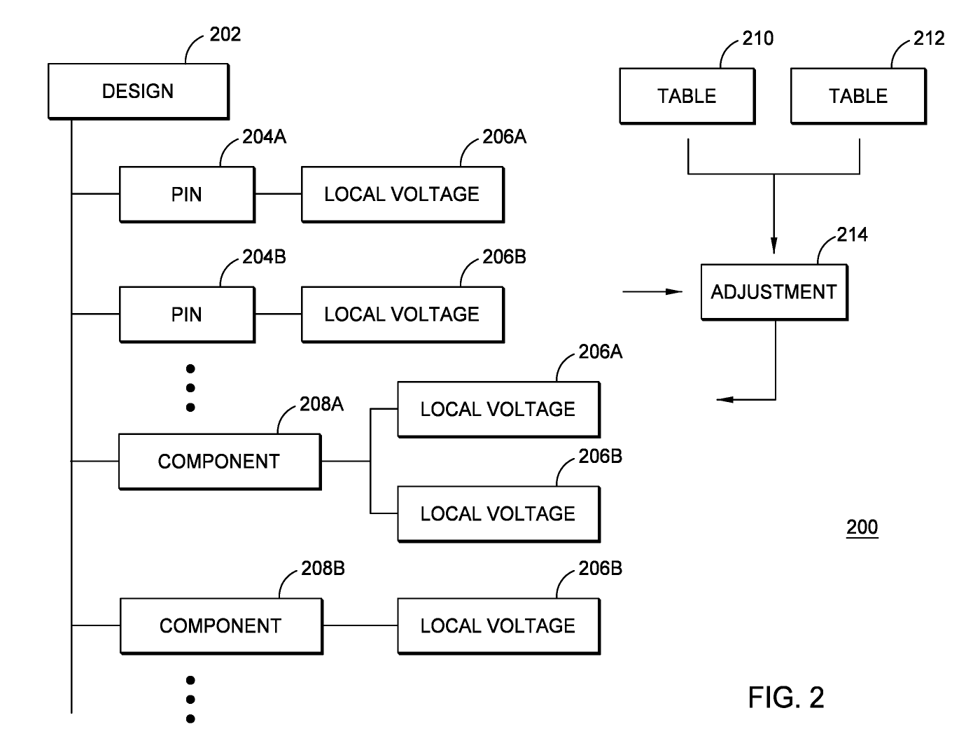

FIG. 2 illustrates an example operation 200. A computer system (e.g., that includes the computer 701 shown in FIG. 7) performs the operation 200 to determine and make an adjustment to a design.

The computer system begins with a design 202. The design 202 may be the design for a module in the circuit design. The design 202 may be instantiated multiple times in the circuit design to generate multiple modules in the circuit design. The design 202 includes one or more pins 204. The pins 204 may be used to provide external electrical connections. For example, in an instance of the design 202, the pins 204 may be used to electrically connect to other modules or components in the circuit design. In the example of FIG. 2, the design 202 includes the pins 204A and 204B. The design 202 also includes labels that indicate voltage domains for the signals received on the pins 204. In the example of FIG. 2, the pin 204A receives signals from the voltage domain for the local voltage 206A, and the pin 204B receives signals from the voltage domain for the local voltage 206B.

The design 202 also includes components 208, which may be electrical components such as logic gates, registers, etc. These components 208 may include any number of inputs and receive any number of input signals. The design 202 also includes labels that indicate the voltage domains for the signals received at the inputs of the components 208. In the example of FIG. 2, the component 208A has two inputs. One input receives signals from the voltage domain for the local voltage 206A, and the other input receives signals from the voltage domain for the local voltage 206B. The component 208B has one input that receives signals from the voltage domain for the local voltage 206B.

Because the component 208A receives signals from different voltage domains, there may be a voltage crossing at the component 208A. As a result, the computer system references tables 210 and 212 to determine to which voltage domain the component 208A should belong to prevent illegal voltage crossings from forming in instances of the design 202. The computer system may have generated the table 210 when instantiating the design 202 in the circuit design. The computer system may have been provided the table 212 from a circuit designer or operator of the computer system. Although the present disclosure describes the system referencing tables, it is understood that the computer system may reference any type of data structure to determine to which voltage domain the component 208A should belong. For example, the computer system may reference a list, a tree, a graph, etc.

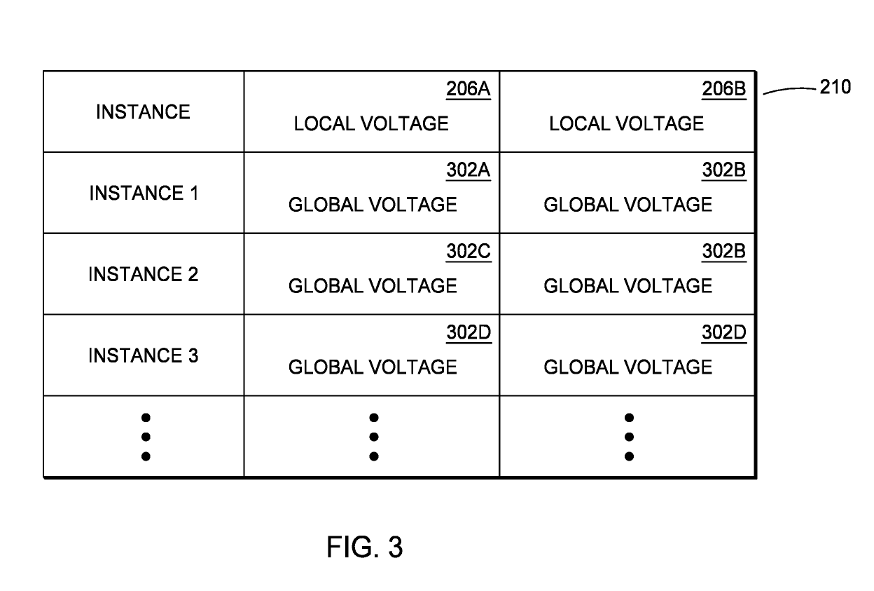

The table 210 indicates the global voltages in the circuit design mapped to the local voltages in the design 202. For example, the table 210 may indicate, for each instance of the design 202 in the circuit design, the voltage domains (indicated by the global voltages) to which the signals received by that instance belong. FIG. 3 illustrates an example table 210. As seen in FIG. 3, the table 210 indicates that the circuit design includes INSTANCE 1, INSTANCE 2, and INSTANCE 3 of the design. In INSTANCE 1, the local voltage 206A is mapped to the global voltage 302A, and the local voltage 206B is mapped to the global voltage 302B. As a result, in INSTANCE 1, signals from the voltage domain for the local voltage 206A are from the voltage domain for the global voltage 302A, and signals from the voltage domain for the local voltage 206B are from the voltage domain for the global voltage 302B. In INSTANCE 2, the local voltage 206A is mapped to the global voltage 302C, and the local voltage 206B is mapped to the global voltage 302B. As a result, in INSTANCE 2, signals from the voltage domain for the local voltage 206A are from the voltage domain for the global voltage 302C, and signals from the voltage domain for the local voltage 206B are from the voltage domain for the global voltage 302B. In INSTANCE 3, the local voltage 206A is mapped to the global voltage 302D, and the local voltage 206B is mapped to the global voltage 302D. As a result, in INSTANCE 3, signals from the voltage domains for the local voltages 206A and 206B are from the voltage domain for the global voltage 302D.

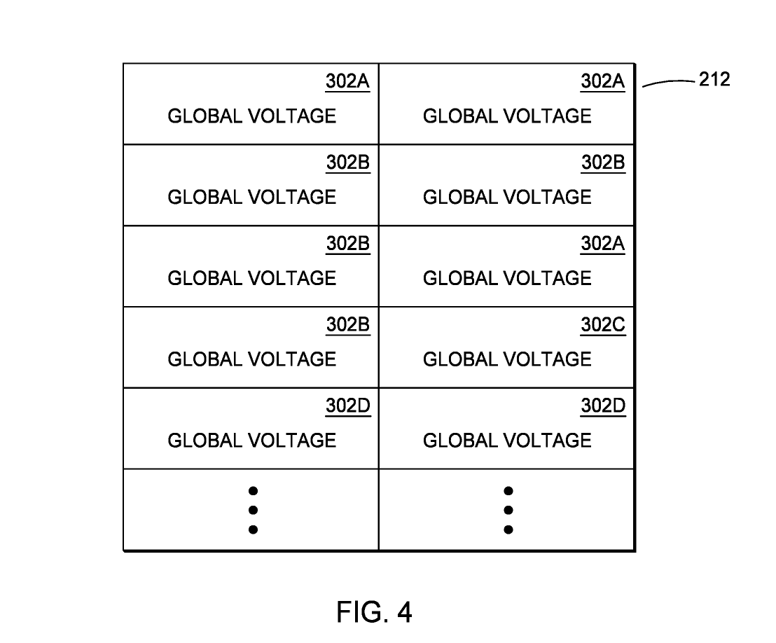

The table 212 indicates the voltage crossings that are legal in the circuit design (which may also be referred to as allowed direct crossings). FIG. 4 illustrates an example table 212. As seen in FIG. 4, the table 212 indicates that voltage crossings from global voltage 302A to global voltage 302A are allowed direct crossings, that voltage crossings from global voltage 302B to global voltage 302B are allowed direct crossings, and that voltage crossings from global voltage 302D to global voltage 302D are allowed direct crossings. Additionally, the table 212 indicates that voltage crossings from global voltage 302B the global voltage 302A are allowed direct crossings and that voltage crossings from global voltage 302B to global voltage 302C are allowed direct crossings. In certain embodiments, if the table 212 does not include a particular voltage crossing (e.g., from global voltage 302A to global voltage 302B), then the table 212 may implicitly indicate that that voltage crossing is illegal.

Returning to the example of FIG. 2, the computer system may use the tables 210 and 212 to determine whether the component 208A may be assigned to a voltage domain for a local voltage while avoiding illegal voltage crossings. For example, the computer system may determine that the component 208A includes a voltage crossing because the component 208A receives signals from the voltage domain for the local voltage 206A and the voltage domain for the local voltage 206B. Referencing the table 210 shown in FIG. 3, the computer system determines that the voltage crossings in the circuit design involve (i) global voltage 302A and global voltage 302B, (ii) global voltage 302C and global voltage 302B, and (iii) global voltage 302D and global voltage 302D. Referencing the table 212 shown in FIG. 4, the computer system determines that the following voltage crossings are allowed direct crossings: (i) from global voltage 302B to global voltage 302, (ii) from global voltage 302B to global voltage 302C, and (iii) from global voltage 302D to global voltage 302D. The computer system then determines, from the information in the table 210, that each of the legal voltage crossings are mapped from the local voltage 206B to the local voltage 206A. In response, the computer system then determines that if the component 208A were assigned to the voltage domain for the local voltage 206A, then illegal voltage crossings at the component 208A may be avoided.

The computer system may then make an adjustment 214 to the design 202 to indicate that the component 208A should be assigned to the voltage domain for the local voltage 206A. For example, the computer system may add a label to the design 202 to indicate that the component 208A should be powered using the local voltage 206A. As another example, the computer system may change metadata in the design 202 to indicate that the component 208A should be powered using the local voltage 206A. Doing so would allow both signals received at the component 208A to have a legal voltage crossing. If the component 208A were instead powered using the local voltage 206B, then illegal voltage crossings would occur (e.g., global voltage 302B to global voltage 302A or global voltage 302B to global voltage 302C). The computer system then makes the adjustment 214 to the design 202 to indicate that the component 208A should be powered using the local voltage 206A. Instances of the design 202 in the circuit design may then power the corresponding component 208A in the instance using the corresponding global voltage indicated in the table 210.

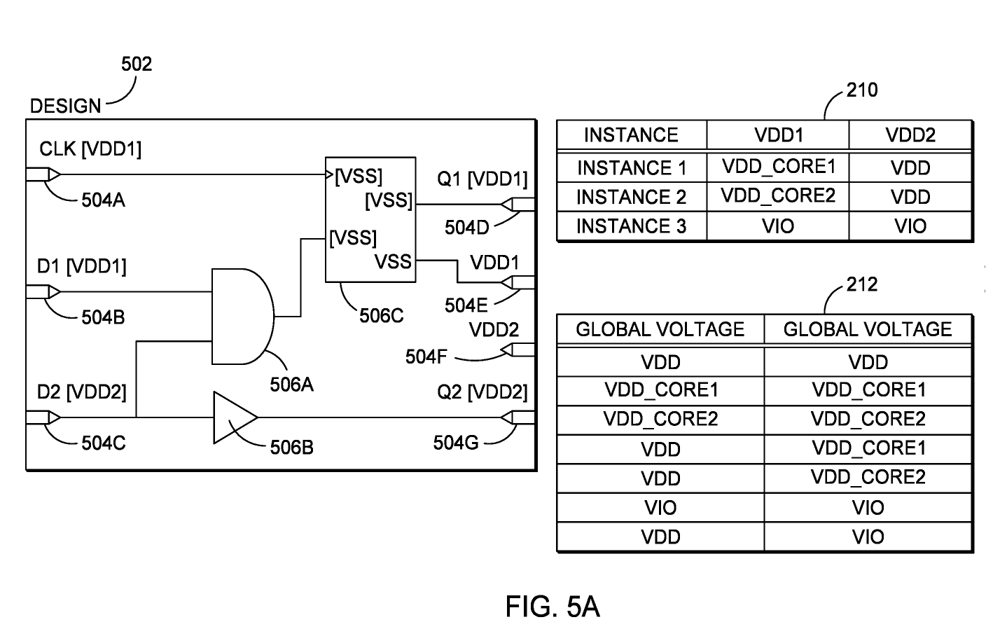

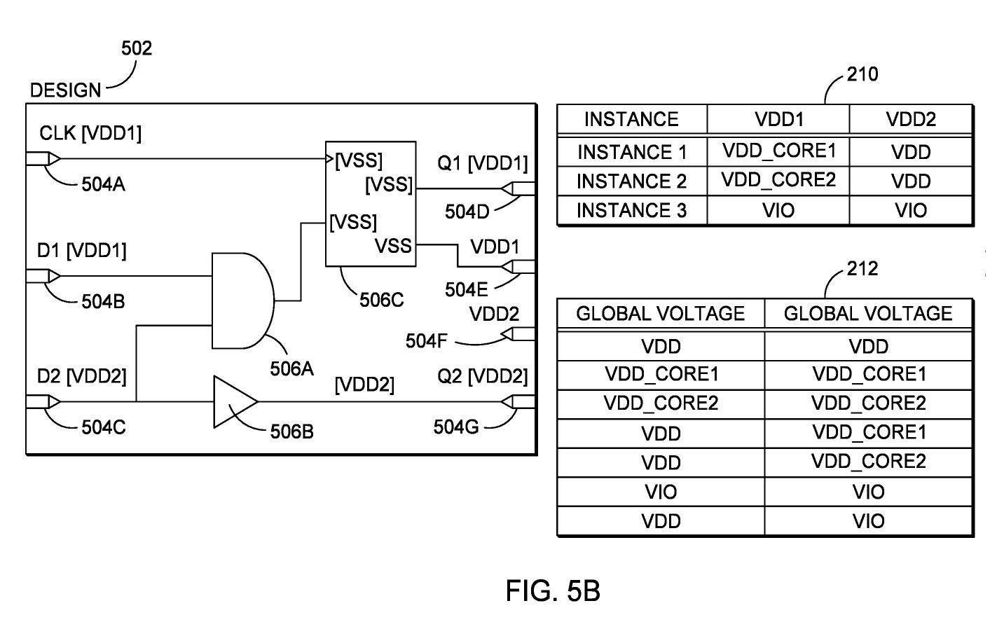

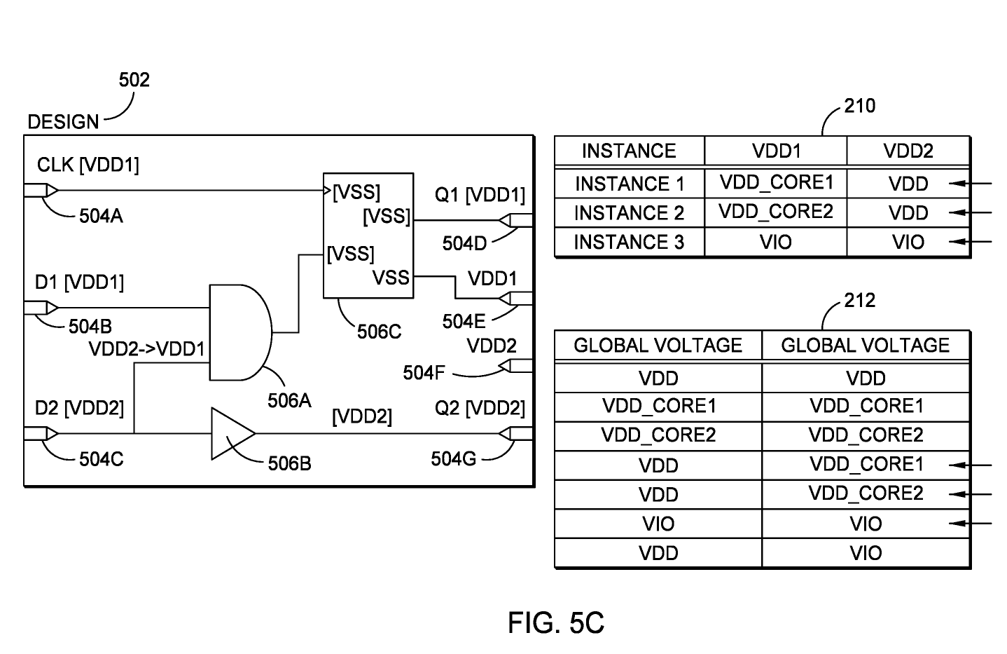

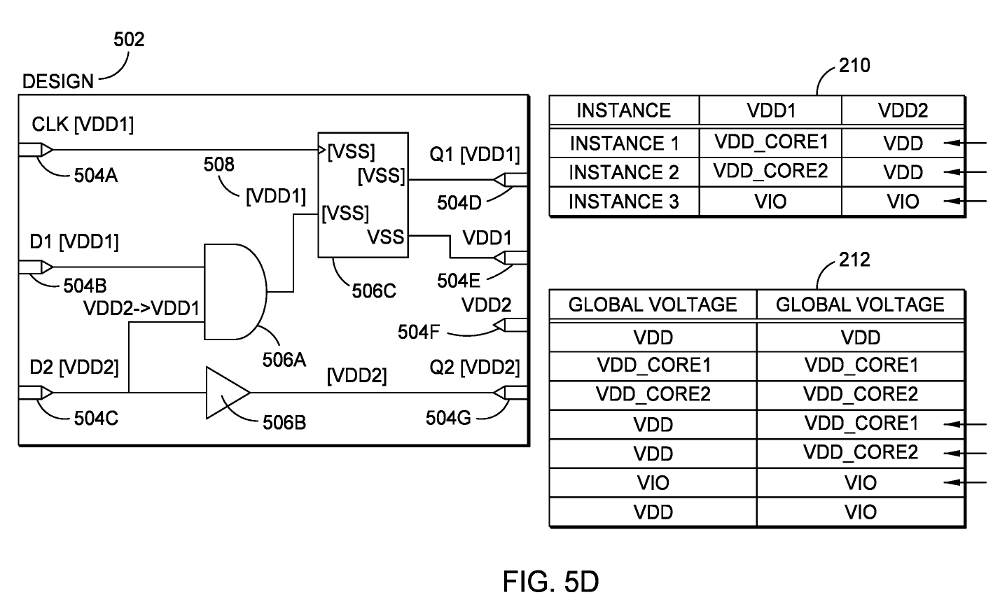

FIGS. 5A through 5D illustrate an example circuit design adjustment. A computer system (e.g., that includes the computer 701 shown in FIG. 7) performs the circuit design adjustment. The computer system begins with a design 502 for a module. As seen in FIG. 5A, the design 502 includes pins 504A, 504B, 504C, 504D, 504E, 504F, and 504G and components 506A, 506B, and 506C. The component 506A is an AND gate. The component 506B is a buffer. The component 506C is a register. The pin 504A receives a clock signal (CLK). The pin 504B receives data (D1). The pin 504C receives data (D2). The pin 504D receives an output of the component 506C (Q1). The pin 504E receives a voltage (VDD1) that powers the component 506C. The pin 504F receives a voltage (VDD2). The pin 504G receives an output of the component 506B (Q2). The component 506A receives the signal D1 from the pin 504B and the signal D2 from the pin 504C. The component 506B receives the signal D2 from the pin 504C. The component 506C receives the clock signal from the pin 504A and the output of the component 506A.

Additionally, the design 502 includes labels or annotations that indicate the voltage domain from which the pins 504A, 504B, 504C, 504D, 504E, 504F, and 504G receive signals. The pin 504A receives the clock signal that comes from the voltage domain for VDD1. The pin 504B receives D1 from the voltage domain for VDD1. The pin 504C receives D2 from the voltage domain for VDD2. The pin 504D receives Q1 from the voltage domain for VDD1 (e.g., because the component 506C is powered using VDD1 from the pin 504E). The pin 504E receives signals from the voltage domain for VDD1 (e.g., because the pin 504E supplies the voltage VDD1). The pin 504F receives signals from the voltage domain for VDD2 (e.g., because the pin 504F supplies the voltage VDD2). The pin 504G receives signals from the voltage domain for VDD2 (e.g., because the component 506B buffers the signal D2 from the voltage domain for VDD2).

The computer system references the table 210, which may have been generated when the design 502 was instantiated into a circuit design. As seen in FIG. 5A, the table 210 maps the local voltages (VDD1 and VDD2) to global voltages in the circuit design that includes multiple instances of the design 502. According to the table 210, there are three instances of the design 502 in the circuit design: INSTANCE 1, INSTANCE 2, and INSTANCE 3. In INSTANCE 1, VDD1 is mapped to global voltage VDD_CORE1 and VDD2 is mapped to global voltage VDD. In INSTANCE 2, VDD1 is mapped to global voltage VDD_CORE2 and VDD2 is mapped to global voltage VDD. In INSTANCE 3, VDD1 is mapped to global voltage VIO and VDD2 is mapped to global voltage VIO.

The computer system also references the table 212, which may have been provided by a circuit designer or operator of the computer system. As seen in FIG. 5A, the table 212 shows the legal voltage crossings in the circuit design. According to the table 212, the following voltage crossings are allowed direct crossings: (i) VDD to VDD, (ii) VDD_CORE1 to VDD_CORE1, (iii) VDD_CORE2 to VDD_CORE2, (iv) VDD to VDD_CORE1, (v) VDD to VDD_CORE2, (vi) VIO to VIO, and (vii) VDD to VIO.

The computer system adjusts the design 502 to indicate that the component 506B should be powered using the local voltage VDD2, which places the component 506B in the voltage domain for VDD2. For example, the computer system may determine that both the input and output of the component 506B are in the voltage domain for VDD2. In response, the computer system may determine that the component 506B should be powered using the local voltage VDD2. The computer system adds a label [VDD2] to the design 502 to indicate that the component 506B should be powered using VDD2. As another example, the computer system adjust metadata of the design 502 to indicate that the component 506B should be assigned to the voltage domain for VDD2, which may not be visible in the design 502.

As seen in FIG. 5C, the computer system may also determine that a voltage crossing occurs at the component 506A, because the component 506A receives input signals from different voltage domains, D1 from the voltage domain for VDD1 and D2 from the voltage domain for VDD2. The computer system uses the information in the tables 210 and 212 to determine to which voltage domain the component 506A should belong and/or how to power the component 506A. The table 210 indicates that the global voltage domains involved in the instances of the design 502 includes (i) VDD_CORE1 and VDD, (ii) VDD_CORE2 and VDD, and (iii) VIO and VIO. The computer system determines from the table 212 that (i) a voltage crossing from VDD to VDD_CORE1 is legal, (ii) a voltage crossing from VDD to VDD_CORE2 is legal, and (iii) a voltage crossing from VIO to VIO is legal. Using this information, the computer system may determine that the component 506A should be assigned to the voltage domain for VDD1 and that the component 506A should be powered using VDD1 to avoid introducing illegal voltage crossings.

As a result, the computer system may verify that it is possible to avoid illegal voltage crossings in the design 502. The computer system may update the metadata of the design 502 to indicate that the design 502 is verified. The instances of the design 502 in the circuit design may also be considered verified. In this manner, the computer system verifies every instance of the design 502 without checking each instance individually, which reduces the amount of computing resources and time it takes to verify voltage crossings in the circuit design.

As seen in FIG. 5D, the computer system adjusts the design 502 by adding a label or annotation 508 to the design 502. The label 508 indicates that the component 506A should be powered using the local voltage VDD1 such that the component 506A belongs to the voltage domain for VDD1. According to the table 210, the computer system may then power the different instances of the component 506A using the global voltages mapped to VDD1 (e.g., VDD_CORE1, VDD_CORE2, and VIO). In this manner, the computer system verifies the voltage crossings in the design 502 rather than in the instances of the design 502. In some embodiments, the adjustment to the design 502 may be to the metadata of the design 502 and may not result in a visual change to the design 502.

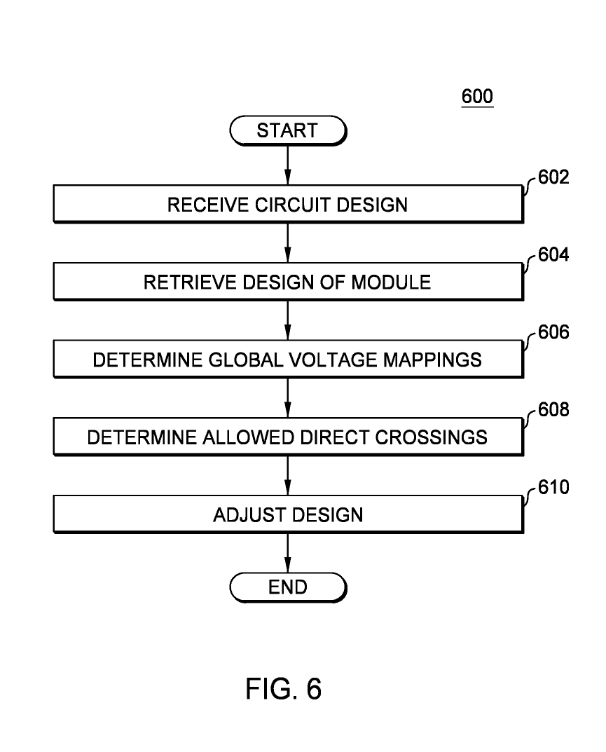

FIG. 6 is a flowchart of an example method 600. In certain embodiments, a computer system (e.g., that includes the computer 701 shown in FIG. 7) performs the method 600. By performing the method 600, the computer system verifies voltage crossings in a circuit design.

At block 602, the computer system receives a circuit design. The circuit design may include multiple modules. These modules may be instances of the same design. As a result, the modules may include the same electrical components and electrical connections. The modules may be connected to different modules or components of the circuit design. At block 604, the computer system retrieves the design of the module. The design of the module may show the components of the design. Additionally, the design may include labels indicating the voltage domains from which certain pins receive signals. The computer system may analyze the design to determine a component of the design (e.g., a logic gate) that presents a voltage crossing. For example, the component may receive input signals from two different voltage domains.

At block 606, the computer system determines global voltage mappings for these voltage domains. The computer system may reference a first table that maps global voltages to the local voltages in the design for the various instances of the design in the circuit design. At block 608, the computer system determines allowed direct crossings or allowed voltage crossings using a second table. The computer system references the second table, which may identify the allowed direct crossings in the circuit design.

At block 610, the computer system adjusts the design. For example, the computer system may use the information in the first table and the second table to determine to what voltage domain the component of the design should belong to avoid introducing an illegal voltage crossing. If the computer system determines that it is possible to satisfy the restrictions in the first table and/or the second table, then the computer system may consider the voltage crossing for the component verified. The computer system adds a label to the design to indicate the local voltage for that voltage domain should be used to power the component. The computer system may then use this label and the information in the first table to determine how to power the instances of the component in the circuit design. In some embodiments, the computer system adjusts the design by adjusting the metadata for the design to indicate the voltage domain to which the component should be assigned. This adjustment may not cause a visible change to the design.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 7 shows an example computer environment 700. Computing environment 700 contains an example of an environment for the execution of at least some of the computer code involved in performing the described methods, such as the method for verifying voltage crossings in a circuit design. In addition, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and code 780, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 721 and the other storage media discussed below. The program instructions, and associated data, are accessed by processor set 710 to control and direct performance of the disclosed methods. In computing environment 700, at least some of the instructions for performing the disclosed methods may be stored in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code 780 typically includes at least some of the computer code involved in performing the methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the disclosed methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

CLOUD COMPUTING SERVICES AND/OR MICROSERVICES (not separately shown in FIG. 7): private and public clouds 706 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

While the foregoing is directed to embodiments of the present disclosure, other and further embodiments may be devised without departing from the basic scope thereof, and the scope thereof is determined by the claims that follow.

What is claimed is:

1. A computer system comprising:
a processor set;
one or more computer-readable storage media; and
program instructions stored on the one or more storage media to cause the processor set to perform operations comprising:
receiving a circuit design comprising a first instance of a module;
retrieving a design of the module, wherein the design of the module comprises (i) a first pin corresponding to a first local voltage, (ii) a second pin corresponding to a second local voltage, and (iii) a first component, and wherein the first component comprises (i) a first input corresponding to the first local voltage and (ii) a second input corresponding to the second local voltage;
determining (i) a first global voltage mapped to the first local voltage for the first instance of the module and (ii) a second global voltage mapped to the second local voltage for the first instance of the module;
determining that a crossing from the second global voltage to the first global voltage is allowed; and
based on the crossing from the second global voltage to the first global voltage being allowed, adjusting the design of the module such that the first component is powered using the first local voltage.

2. The computer system of claim 1, wherein the first component is a logic gate.

3. The computer system of claim 1, wherein:
the design of the module further comprises a second component comprising a third input corresponding to the second local voltage; and
the operations further comprise adjusting the design of the module such that the second component is powered using the second local voltage.

4. The computer system of claim 1, wherein:
the circuit design further comprises a second instance of the module;
determining that (i) the first global voltage is mapped to the first local voltage for the first instance of the module and (ii) the second global voltage is mapped to the second local voltage for the first instance of the module is based on a first table; and
the first table (i) maps a third global voltage to the first local voltage for the second instance of the module and (ii) maps the second global voltage to the second local voltage for the second instance of the module.

5. The computer system of claim 4, wherein:
determining that the crossing from the second global voltage to the first global voltage is allowed is based on a second table;
the second table indicates a crossing from the second global voltage to the third global voltage is allowed; and
adjusting the design of the module such that the first component is powered using the first local voltage is further based on the crossing from the second global voltage to the third global voltage being allowed.

6. The computer system of claim 1, wherein the operations further comprise adjusting the circuit design such that the first component in the first instance of the module is powered using the first global voltage based on (i) the first component in the design of the module being powered using the first local voltage and (ii) the first global voltage being mapped to the first local voltage for the first instance of the module.

7. The computer system of claim 1, wherein the design of the module indicates that the first input of the first component receives a signal from a component of the circuit design powered using the first local voltage.

8. A computer-implemented method comprising:
receiving a circuit design comprising a first instance of a module;
retrieving a design of the module, wherein the design of the module comprises (i) a first pin corresponding to a first local voltage, (ii) a second pin corresponding to a second local voltage, and (iii) a first component, and wherein the first component comprises (i) a first input corresponding to the first local voltage and (ii) a second input corresponding to the second local voltage;
determining (i) a first global voltage mapped to the first local voltage for the first instance of the module and (ii) a second global voltage mapped to the second local voltage for the first instance of the module;
determining an allowed direct crossing from the second global voltage to the first global voltage; and
based on the allowed direct crossing from the second global voltage to the first global voltage, adjusting the design of the module such that the first component is powered using the first local voltage.

9. The method of claim 8, wherein the first component is a logic gate.

10. The method of claim 8, wherein:
the design of the module further comprises a second component comprising a third input corresponding to the second local voltage; and
the method further comprises adjusting the design of the module such that the second component is powered using the second local voltage.

11. The method of claim 8, wherein:
the circuit design further comprises a second instance of the module;
determining that (i) the first global voltage is mapped to the first local voltage for the first instance of the module and (ii) the second global voltage is mapped to the second local voltage for the first instance of the module is based on a first table; and
the first table (i) maps a third global voltage to the first local voltage for the second instance of the module and (ii) maps the second global voltage to the second local voltage for the second instance of the module.

12. The method of claim 11, wherein:
determining that the crossing from the second global voltage to the first global voltage is allowed is based on a second table;
the second table indicates an allowed direct crossing from the second global voltage to the third global voltage; and
adjusting the design of the module such that the first component is powered using the first local voltage is further based on the allowed direct crossing from the second global voltage to the third global voltage.

13. The method of claim 8, further comprising adjusting the circuit design such that the first component in the first instance of the module is powered using the first global voltage based on (i) the first component in the design of the module being powered using the first local voltage and (ii) the first global voltage being mapped to the first local voltage for the first instance of the module.

14. The method of claim 8, wherein the design of the module indicates that the first input of the first component receives a signal from a component of the circuit design powered using the first local voltage.

15. A computer program product comprising:
one or more non-transitory computer-readable storage media; and
program instructions stored on the one or more storage media to perform operations comprising:
receiving a circuit design comprising a first instance of a module;
retrieving a design of the module, wherein the design of the module comprises (i) a first pin corresponding to a first local voltage, (ii) a second pin corresponding to a second local voltage, and (iii) a first component, and wherein the first component comprises (i) a first input corresponding to the first local voltage and (ii) a second input corresponding to the second local voltage;
determining (i) a first global voltage mapped to the first local voltage for the first instance of the module and (ii) a second global voltage mapped to the second local voltage for the first instance of the module;
determining an allowed direct crossing from the second global voltage to the first global voltage; and
based on the allowed direct crossing from the second global voltage to the first global voltage, adjusting the design of the module such that the first component is powered using the first local voltage.

16. The computer program product of claim 15, wherein the first component is a logic gate.

17. The computer program product of claim 15, wherein:
the design of the module further comprises a second component comprising a third input corresponding to the second local voltage; and
the operations further comprise adjusting the design of the module such that the second component is powered using the second local voltage.

18. The computer program product of claim 15, wherein:
the circuit design further comprises a second instance of the module;
determining that (i) the first global voltage is mapped to the first local voltage for the first instance of the module and (ii) the second global voltage is mapped to the second local voltage for the first instance of the module is based on a first table; and
the first table (i) maps a third global voltage to the first local voltage for the second instance of the module and (ii) maps the second global voltage to the second local voltage for the second instance of the module.

19. The computer program product of claim 18, wherein:
determining that the crossing from the second global voltage to the first global voltage is allowed is based on a second table;
the second table indicates an allowed direct crossing from the second global voltage to the third global voltage; and
adjusting the design of the module such that the first component is powered using the first local voltage is further based on the allowed direct crossing from the second global voltage to the third global voltage.

20. The computer program product of claim 15, wherein the operations further comprise adjusting the circuit design such that the first component in the first instance of the module is powered using the first global voltage based on (i) the first component in the design of the module being powered using the first local voltage and (ii) the first global voltage being mapped to the first local voltage for the first instance of the module.
